(19) United States
(12) Patent Application Publication
(10) Pub. No.: US 2015/0193708 A1
(43) Pub. Date: Jul. 9, 2015

(54) PERSPECTIVE ANALYZER

(71) Applicant: International Business Machines Corporation, Armonk, NY (US)

(72) Inventors: Francis X. Reddington, Sarasota, FL (US); Neil Sahota, Mesa, CA (US)

(73) Assignee: International Business Machines Corporation, Armonk, NY (US)

(21) Appl. No.: 14/147,629

(22) Filed: Jan. 6, 2014

(51) Int. Cl. G06Q 10/06

(52) U.S. Cl. CPC G06Q 10/0637

(57) ABSTRACT

A method and associated system for identifying a perspective or point of view from which a user may effectively evaluate an objective. A processor creates and partially populates a user-perspective data structure that represents information and logic associated with a user's current point of view about the objective. The processor asks the user contextual questions and uses the answers to further populate the user perspective data structure, to identify user biases, and to select previously stored “baseline” perspectives that may be relevant to the user and to the objective. The processor compares each selected baseline perspective to the user perspective and ranks the baselines in order of how similar or relevant each is to the user and to the objective. The user is then presented with one or more baseline perspectives that are most relevant, accurate, feasible, or contextually appropriate to the user and to the objective.

### TECHNICAL FIELD

The present invention relates to identifying a perspective or point of view from which one or more users may effectively identify, analyze, evaluate, or otherwise assess an idea, strategy, process, product, opportunity, proposal, or other entity or objective of a business plan, priority, or goal.

### BACKGROUND

A business plans may fail even when the plan is meticulously constructed by professionals who are intimately familiar with business and market conditions that may affect the plan's chances of success. This may happen even when those professionals know in advance of the factors that ultimately cause the plan to fail, or when a professional has a history of success in similar endeavors.

This may occur when an individual or organization fails to evaluate a merit of a plan from a perspective that is appropriate to the plan and to its context, or that fails to reconsider a perspective that had once before been found to be effective. By failing to thus properly evaluate an idea, strategy, process, product, opportunity, proposal, or other entity or objective of a business plan, a business or other organization may find itself facing stagnation, lost opportunities, an inability to react quickly to changing market conditions, unacceptable talent development, or other problems that may stunt the organization's growth, revenue, or an other measure of success.

### BRIEF SUMMARY

A first embodiment of the present invention provides a method for selecting a recommended perspective with which a user may identify a course of action for achieving an objective, wherein the recommended perspective is represented as an instance of a plurality of stored instances of a perspective database schema, the method comprising:

a processor of a computer system initializing a user-perspective data structure, wherein the user-perspective data structure is an instance of the perspective database schema, and wherein the user-perspective data structure is associated with the user's current perspective about the objective;

the processor selecting a sequence of questions as a function of a characteristic of the user;

the processor presenting the sequence of questions to the user;

the processor recording a set of answers returned by the user in response to the presenting;

the processor identifying as a function of the answers a user bias in the user's current perspective;

the processor revising the user-perspective data structure as a function of the identifying a user bias;

the processor choosing a set of baseline perspectives from the plurality of stored instances of the perspective database schema;

the processor comparing the user-perspective data structure to a selected baseline perspective of the set of baseline perspectives;

the processor assigning a score to the selected baseline perspective as a function of a similarity between a first set of information stored in the user-perspective data structure and a second set of information stored in the selected baseline perspective; and

the processor ranking the set of baseline perspectives as a function of the assigning;

the processor selecting the recommended perspective from the set of baseline perspectives as a function of the ranking.

A second embodiment of the present invention provides a computer program product, comprising a computer-readable hardware storage device having a computer-readable program code stored therein, said program code configured to be executed by a processor of a computer system to implement a method for selecting a recommended perspective with which a user may identify a course of action for achieving an objective, wherein the recommended perspective is represented as an instance of a plurality of stored instances of a perspective database schema, the method comprising:

the processor initializing a user-perspective data structure, wherein the user-perspective data structure is an instance of the perspective database schema, and wherein the user-perspective data structure is associated with the user's current perspective about the objective;

the processor selecting a sequence of questions as a function of a characteristic of the user;

the processor presenting the sequence of questions to the user;

the processor recording a set of answers returned by the user in response to the presenting;

the processor identifying as a function of the answers a user bias in the user's current perspective;

the processor revising the user-perspective data structure as a function of the identifying a user bias;

the processor choosing a set of baseline perspectives from the plurality of stored instances of the perspective database schema;

the processor comparing the user-perspective data structure to a selected baseline perspective of the set of baseline perspectives;

the processor assigning a score to the selected baseline perspective as a function of a similarity between a first set of information stored in the user-perspective data structure and a second set of information stored in the selected baseline perspective; and

the processor ranking the set of baseline perspectives as a function of the assigning;

the processor selecting the recommended perspective from the set of baseline perspectives as a function of the ranking.

A third embodiment of the present invention provides a computer system comprising a processor, a memory coupled to said processor, and a computer-readable hardware storage device coupled to said processor, said storage device containing program code configured to be run by said processor via the memory to implement a method for selecting a recommended perspective with which a user may identify a course of action for achieving an objective, wherein the recommended perspective is represented as an instance of a plurality of stored instances of a perspective database schema, the method comprising:

the processor initializing a user-perspective data structure, wherein the user-perspective data structure is an instance of the perspective database schema, and wherein the user-perspective data structure is associated with the user's current perspective about the objective;

the processor selecting a sequence of questions as a function of a characteristic of the user;

the processor presenting the sequence of questions to the user;

the processor recording a set of answers returned by the user in response to the presenting;

the processor identifying as a function of the answers a user bias in the user's current perspective;

the processor revising the user-perspective data structure as a function of the identifying a user bias;

the processor choosing a set of baseline perspectives from the plurality of stored instances of the perspective database schema;

the processor comparing the user-perspective data structure to a selected baseline perspective of the set of baseline perspectives;

the processor assigning a score to the selected baseline perspective as a function of a similarity between a first set of information stored in the user-perspective data structure and a second set of information stored in the selected baseline perspective; and

the processor ranking the set of baseline perspectives as a function of the assigning;

the processor selecting the recommended perspective from the set of baseline perspectives as a function of the ranking.

### BRIEF DESCRIPTION OF THE DRAWINGS

FIG. 1 shows the structure of a computer system and computer program code that may be used to implement a method for perspective analysis with embodiments of the present invention.

FIG. 2 is a structure diagram that shows relationships among component modules of a perspective analyzer in accordance with embodiments of the present invention.

FIG. 3 is a flow chart that illustrates steps of a method for perspective analysis in accordance with embodiments of the present invention.

FIG. 4A illustrates a high-level organization of a minimum embodiment of a perspective data model, in accordance with embodiments of the present invention.

FIG. 4B illustrates details of items of FIG. 4A that show the Questions & Answer substructure, the Objectives & Domain substructure, and the Context & Relevance substructure of a minimum perspective data structure in accordance with embodiments of the present invention.

FIG. 4C illustrates details of items of FIG. 4A that show the Perspectives & Influencers substructure and the Analysis substructure of a minimum perspective data structure in accordance with embodiments of the present invention.

FIG. 4D illustrates details of items of FIG. 4A that show the Strategies & Alignment substructure and the Ideas, Products, Processes, & Opportunities substructure of a minimum perspective data structure in accordance with embodiments of the present invention.

FIG. 4E shows details of FIG. 4A's Cost/Benefit substructure of a minimum perspective data structure in accordance with embodiments of the present invention.

### DETAILED DESCRIPTION

Embodiments of the present invention provide a means of quantitatively representing, characterizing, and evaluating a perspective from which an organization may evaluate an objective comprised by a business strategy, road map, or other entity of a business plan. Such an objective may comprise, but is not limited to, a combination of ideas, strategies, processes, products, opportunities, proposals, and other entities that may be comprised by the plan.

Here, a perspective is defined as a viewpoint from which an idea, strategy, product, opportunity or other entity or objective may be evaluated. Not all perspectives are appropriate to a particular evaluation or project, however. Two businesses or individuals may embrace clearly distinct perspectives, each of which may be further distinguished by its association with a different set of biases, and even a perspective that was once appropriate, accurate, and possessed of predictive value may in time become unreliable. Embodiments of the present invention provide a way to capture, represent, and compare data, context, and logical relationships comprised by a set of such viewpoints or perspectives, and to identify which such viewpoints are most useful or accurate in evaluating a particular idea, strategy, process, product, opportunity, proposal, or other objective under consideration.

This representation of a perspective may be comprised by a “user perspective” data structure that comprises elements of data and relationships among those elements, wherein the data and relationships represent characteristics of and contextual information about the objective under evaluation. Embodiments of the present invention populate a “user-perspective data structure” instance of such a data model and use logic embedded within this populated user-perspective data-structure instance to identify one or more existing “baseline perspective” data structures stored in the Perspective Database 201 that are congruent with the populated user-perspective data-structure instance. These congruent perspectives are then scored and ranked, where the highest-ranked perspectives are those that most likely, as a function of weighted, relevant characteristics of the perspectives, to be accurate, free from uncompensated bias, and contextually relevant to the objective under evaluation and to the context within which the objective is being evaluated.

A general method of an embodiment of the present invention may be summarized by the following steps:

i) An administrator or other expert initializes and partially populates a user-perspective data structure as a function of the expert's knowledge of an individual user or user organization, of an objective to be evaluated by the user, and of contextual information related to the user or to the objective. The user-perspective data structure is an instance of a perspective data model, where the instance comprises stored data elements and relationships among stored elements that characterize the user's current viewpoint or “perspective” on the objective. Here, the objective may be an idea, a product, a process, an opportunity, a proposal, a business plan, or some other entity that is under consideration by the user.

ii) The user-perspective data structure is further populated with information derived from the user's answers to a set of questions and that helps define a context within which to better understand the user's viewpoint or perspective on the objective.

iii) The user-perspective data structure is analyzed to determine if the user viewpoint it represents is subject to a bias or an other type of distortion.

iv) Previously stored “baseline perspective” data structure instances of the perspective data structure are selected a function of their relevance to the user's viewpoint represented by the user-perspective data structure. Each baseline viewpoints represented by a selected baseline data structure is compared to the user viewpoint and is ranked as a function of how similar the baseline viewpoint is to the user viewpoint.

v) One or more highest-ranked relevant viewpoints are presented to the user with a recommendation that the user adopt that viewpoint when considering the objective under evaluation.

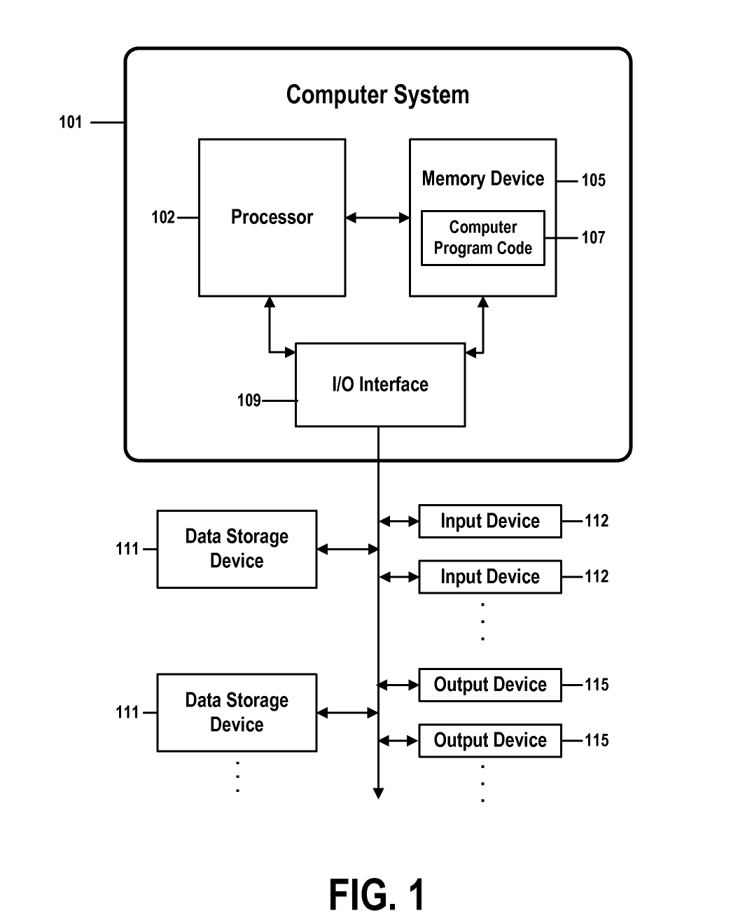

FIG. 1 shows the structure of a computer system and computer program code that may be used to implement a method for perspective analysis in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 1-4E can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 1-4E illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for perspective analysis in accordance with embodiments of the present invention, and may implement other embodiments described in this specification, including the methods illustrated in FIGS. 1-4E. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for perspective analysis.

Any of the components of the present invention could be created, integrated, hosted, maintained, deployed, managed, serviced, supported, etc. by a service provider who offers to facilitate a method for perspective analysis. Thus the present invention discloses a process for deploying or integrating computing infrastructure, comprising integrating computer-readable code into the computer system 101, wherein the code in combination with the computer system 101 is capable of performing a method for perspective analysis.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for generating a service-catalog entry from discovered attributes of provisioned virtual machines may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for generating a service-catalog entry from discovered attributes of provisioned virtual machines is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

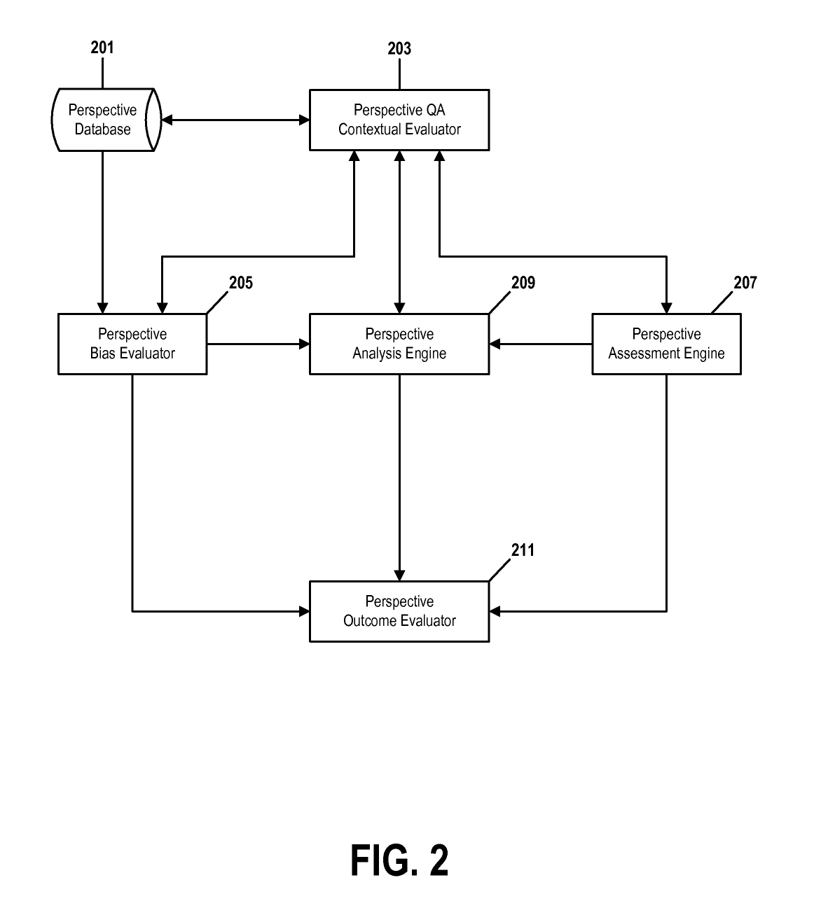

FIG. 2 is a structure diagram that shows relationships among component modules of a perspective analyzer in accordance with embodiments of the present invention. FIG. 2 comprises items 201-211.

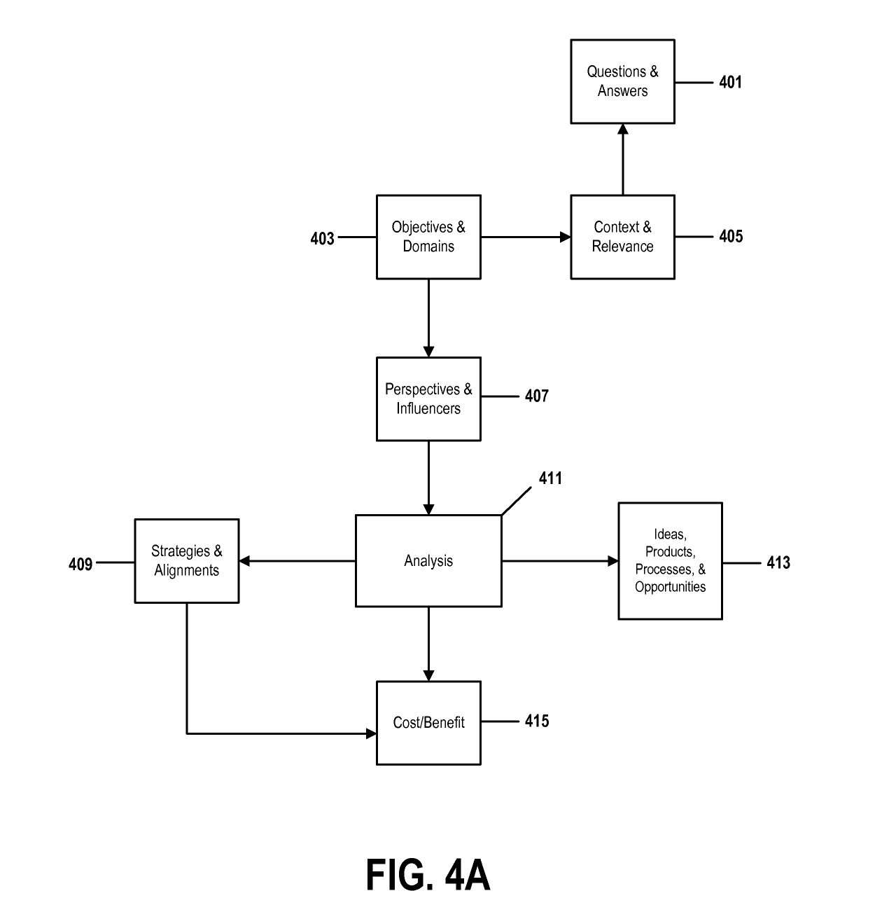

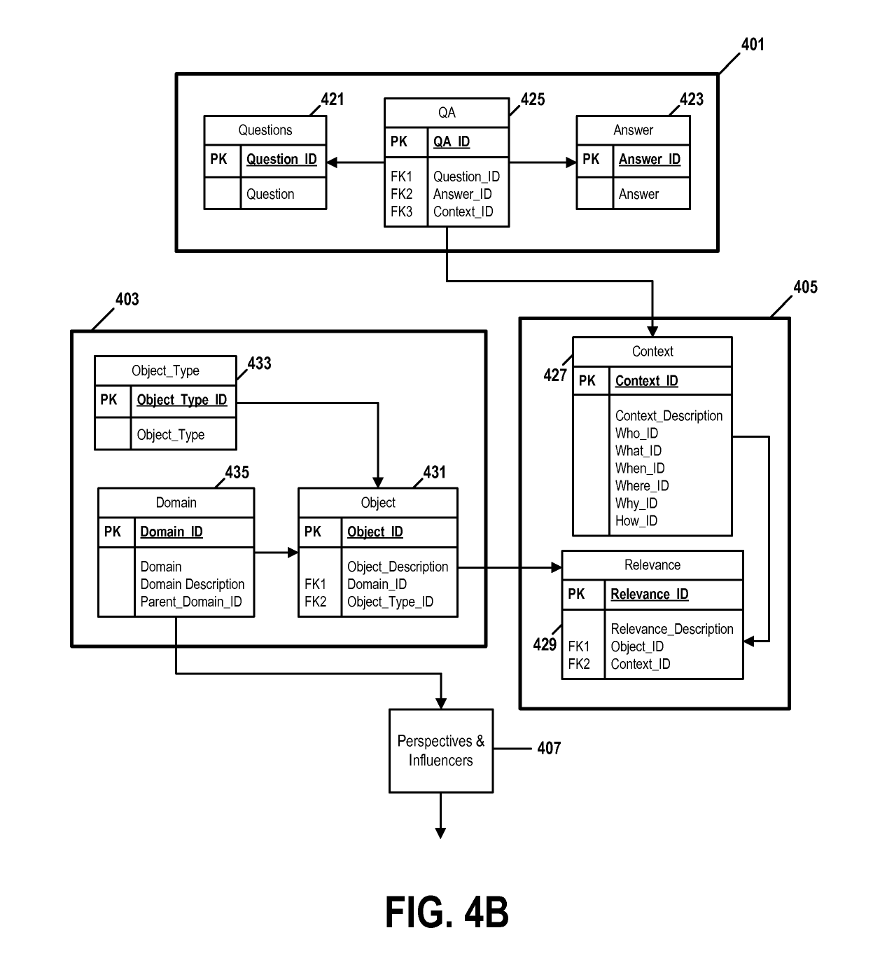

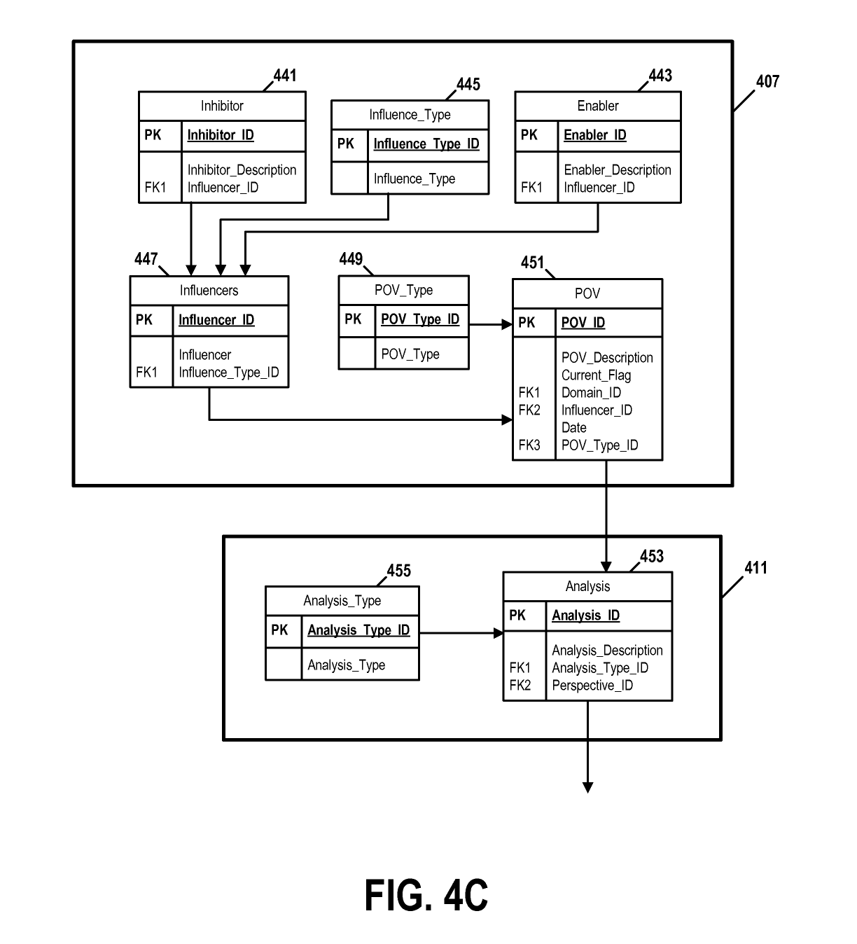

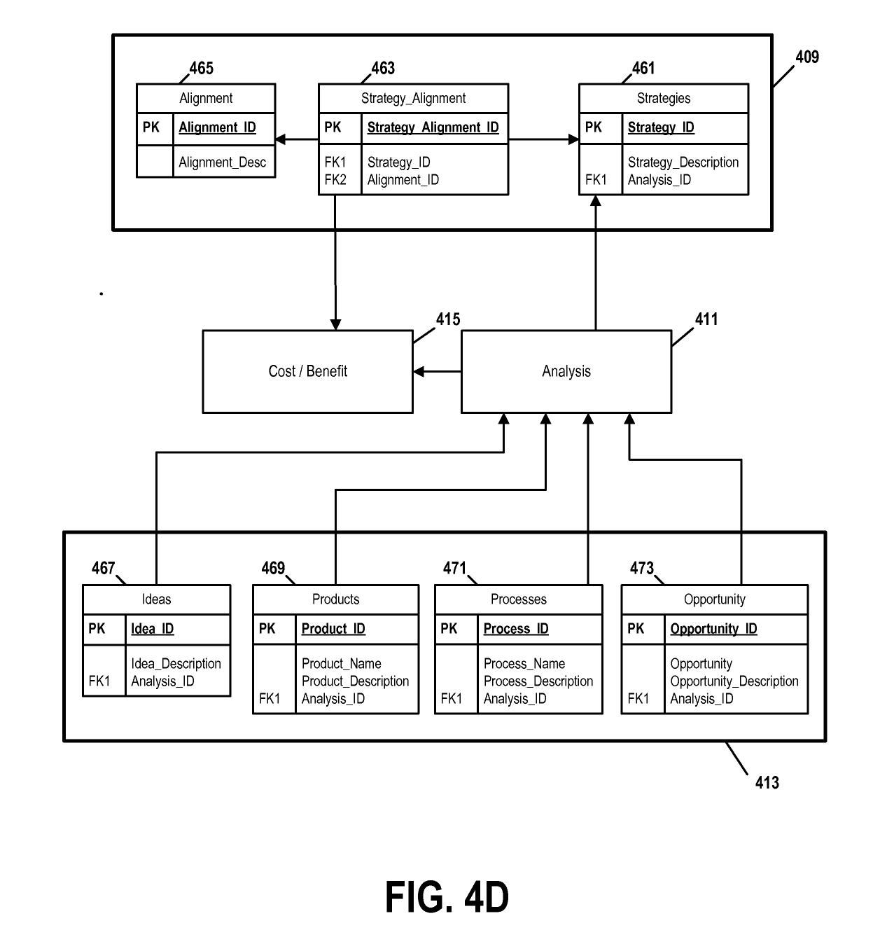

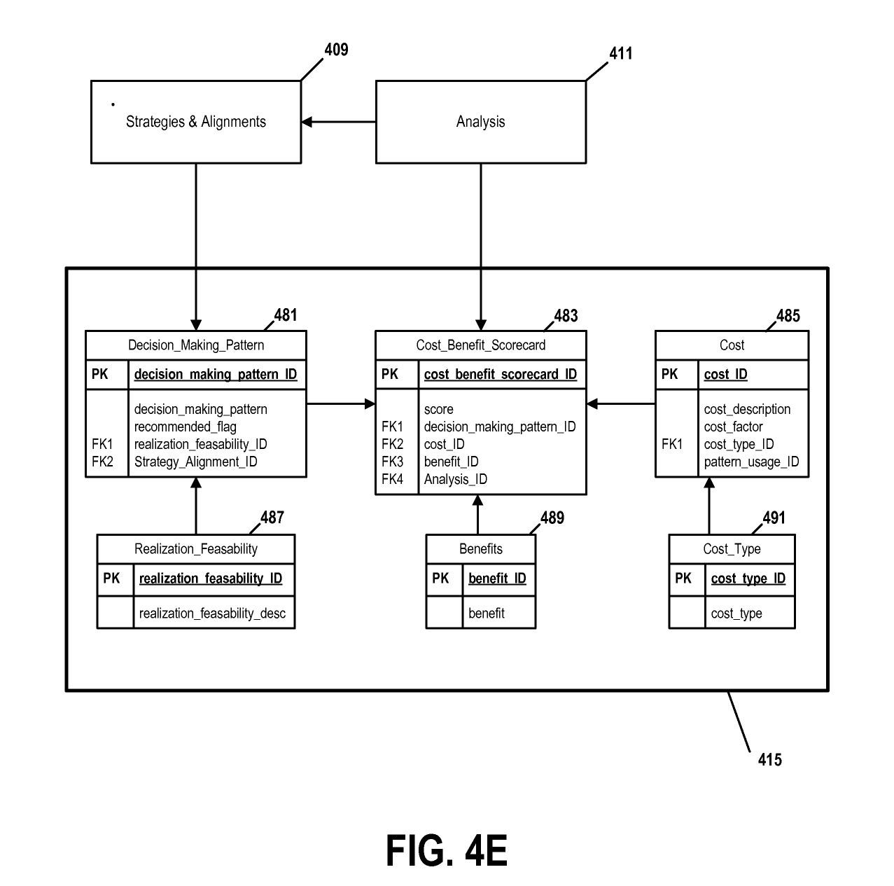

Item 201 is a Perspective Database that stores information created and used by embodiments of the present invention. This information may include a database of perspective data structures that each comprise one instance of a perspective data model. An example of one possible such data model is shown in FIG. 4A-FIG. 4E.

The internal organization of the logical elements and relations comprised by this data model are implementation-dependent and may be chosen as a function of characteristics of: an objective under evaluation; a type of an objective under evaluation; an individual user; a user business; a business plan; an extrinsic marketing, financial, or business issue; or any other factor that may be relevant to a task of identifying an appropriate perspective from which to view or otherwise evaluate an objective of a business plan, priority, or strategy. FIG. 4A-FIG. 4E illustrate a minimum, but extensible, embodiment of such a data model. Depending on the particular needs of an implementation or embodiment, a data model may comprise other or additional tables, records, fields, relations, indexes, or other logical elements.

Some embodiments may comprise multiple data models that are each a function of a characteristic of a user; an objective being evaluated; a business; a business plan, priority, or strategy; a market; an other context of the business plan, priority, or strategy; or an other characteristic of or factor relevant to the business plan, priority, or strategy.

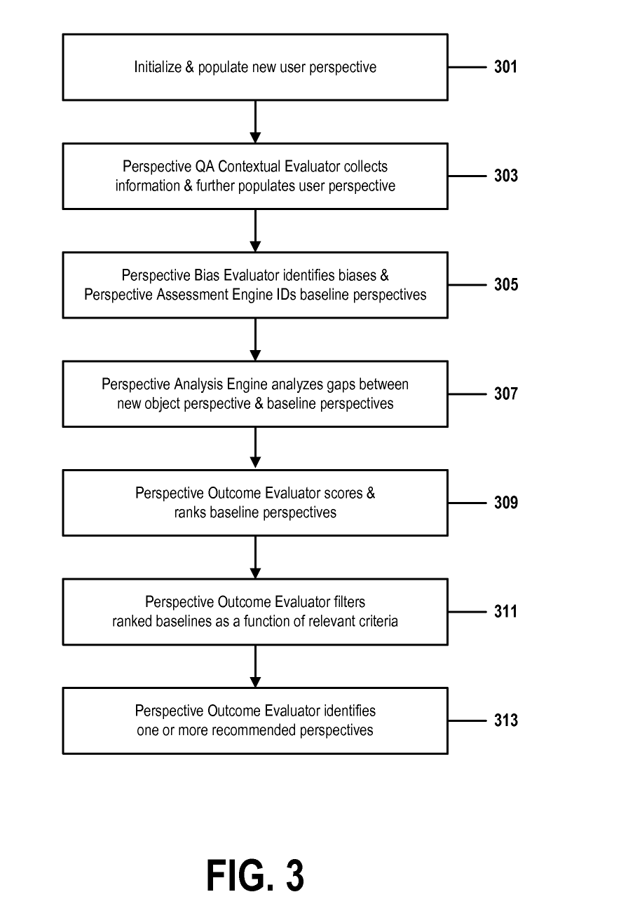

In some embodiments, the logic embedded within the organization of and relations among data elements of this data model may define some of the logic of the method of the present invention. As described in FIG. 3, these embedded relations and logic may facilitate tasks of automatically characterizing, ranking, and selecting one or more perspectives from which to effectively evaluate an objective or other entity of a business plan.

One or more instances of such perspective data models, as well as other information associated with specific perspectives, other contextual information, and other data associated with embodiments of the present invention may be stored in the Perspective Database 201 in any format and by any tools, standards, conventions, methods, or other means known to those skilled in the art. The Perspective Database 201 may, for example, store a perspective data structure as an instance of a perspective data model, where the instance of the perspective data model is represented as a component of a relational database, as one or more flat files, as a set of Excel worksheets, as unstructured text, or in a proprietary format designed to facilitate performance of a method of an embodiment of the present invention.

Item 203 is a Perspective QA Contextual Evaluator module, which may “qualify” or otherwise provide context for a user perspective, represented as a user-perspective data structure that is populated by an embodiment of the present invention, where the user-perspective data structure is stored as an instance of the perspective data model and is associated with the user and with the objective being evaluated. The QA Contextual Evaluator 203 may perform this task by selecting a set of questions that it then presents to one or more users, and by then populating records comprised by the user-perspective data structure as a function of one or more users' answers to one or more of the presented questions.

In embodiments of the present invention, as further explained in the description of FIG. 3, the questions asked by the QA Contextual Evaluator 203 may provide context to the objective under evaluation, to a stored perspective, or to an other entity described by information stored in the Perspective Database 201 or created or used by the embodiments.

In some embodiments, these questions may comprise “who/what/where/when/why/how” questions that identify or characterize information that is contextually related to an objective, perspective, or other entity. The Perspective QA Contextual Evaluator 203 may select and sequence its questions from a pool of predetermined questions as a function of a type of, intended use of or other characteristic of an objective under evaluation. In some cases, a question may be further selected as a function of an answer to a previous question. In some embodiments, a question of the pool of questions may be associated with a type or intended use of idea, opportunity, strategy, process, product, or other objective under evaluation.

One or more of the questions may be selected or worded so as to quantify or distinguish subjective, vague, or ambiguous information, where such quantifying or distinguishing allows the information to be more easily represented as data that may be analyzed by means of a mathematical or logical analysis. In some embodiments, a pool of stored questions may be maintained as records in a Questions table 421 may be continually updated and revised as a function of implementation-dependent updates to known contextual information, or as a function of new information provided by previous or current iterations of an embodiment of the present invention.

Item 205 is a Perspective Bias Evaluator module, which interprets information gathered from sources that may comprise a user answer to a question presented by the Perspective QA Contextual Evaluator 203. This interpreted information may to identify a bias associated with a perspective represented by data stored in the Perspective Database 201 or associated with a user-perspective data structure currently being populated by an embodiment of the present invention. This interpreted information may be a function of an answer to a question selected by the Perspective QA contextual Evaluator 203.

Item 207 is a Perspective Assessment Engine that uses information created by the Perspective QA Contextual Evaluator 203 to select or otherwise identify one or more “baseline” perspective data structures stored in the Perspective Database 201, where the one or more baseline perspectives may be relevant to the objective being evaluated or to a characteristic or context-related entity associated with the objective being evaluated.

Item 209 is a Perspective Analysis Engine module that collects, aggregates, organizes, and analyzes information provided by the Perspective QA Contextual Evaluator 203, the Perspective Bias Evaluator 205, and the Perspective Assessment Engine 207, and then uses the results of this procedure to perform a set of “gap analyses” that identify and quantify a set of “perspective gaps” or incongruities between the current user-perspective data structure associated with the objective being evaluated and each of the baseline perspectives selected or identified by the Perspective Assessment Engine 207. Each such “gap” may indicate how similar (and thus relevant) the user-perspective data structure may be to one of the selected or identified baseline perspectives retrieved from the Perspective Database 201.

Item 211 is a Perspective Outcome Evaluator, which consolidates and analyzes information from the rest of the system to identify a perspective most appropriate to a particular user and objective, to, recommend a way to mitigate an adverse effect organizational bias on a perspective, and to propose an approach for addressing a failure of a user's current perspective.

The Perspective Outcome Evaluator 211 may use results of the gap analysis performed by the Perspective Assessment Engine 207 to select a set of “baseline” perspective data structures from a set of previously generated perspective data structures stored on the Perspective Database 201, where the selected baseline perspective data structures represent perspectives that may be most relevant and appropriate to the user and to the objective being evaluated.

The Perspective Outcome Evaluator 211 then presents the selected baseline perspectives to a user and requests that the user identify which presented perspectives are feasible within the context and constraints of the user's current business strategy and resource availability. The Perspective Outcome Evaluator 211 then ranks and orders the resulting subset of feasible perspectives as a function of the gap analyses performed by the Perspective Analysis Engine 209, and identifies to the user a one or more recommended perspectives that are most relevant to the user and to the objective being evaluated.

FIG. 3 is a flow chart that illustrates steps of a method for a perspective analyzer in accordance with embodiments of the present invention. FIG. 3 contains steps 301-313.

In step 301, embodiments of the present invention initialize and partially populate a new “user-perspective data structure” instance of a perspective data model associated with the embodiment and may store this partially populated new user-perspective data structure in the Perspective Database 201. The perspective data model comprises logical data elements and logical relationships among the data elements. It may be implemented by any means known to those skilled in the art, such as a schema or sub-schema of a relational database, a worksheet template, an unstructured text file, a comma-delimited format, or a set of flat files.

FIGS. 4A-4E illustrate an example of an extensible minimum embodiment of a perspective data model. Such a data model is extensible and may include additional tables, columns, links, or other data structures, data elements, or logical relations that represent a characteristic of a perspective or of any other entity related to a perspective, objective, or other entity described in this document, wherein the represented characteristic may facilitate performance of a step of the method of FIG. 3.

In some embodiments, the initialization procedure of step 301 will comprise an administrator, designer, business specialist, expert, or other responsible person partially populating elements of the user-perspective data structure created in this step. This will be performed as a function of the populating entity's knowledge of or familiarity with a characteristic of, a context of, or a goal of: a business or user being served by the embodiment, an objective being evaluated, or a perspective of the user. In some cases, this initializing partial populating may be performed all or in part by an automated means that populates an element with information transferring, retrieving, inferring, deducing, or copying the information from an extrinsic source.

In one example, consider a perspective currently held by a user when evaluating a product's chance of success, where that perspective considers, among other factors, an effect of consumer confidence upon product sales. If an a business-expert designer who initializes a corresponding user-perspective data structure in step 301 knows, based on the expert's knowledge of the business, that a user's conclusions based on this perspective may be influenced by contemporaneous stock market prices, then the designer may tailor the initializing and populating in order to accurately represent this influencing factor.

The designer might thus in step 301 create a record in the Influencers table 447, which, as shown in FIG. 4C, identifies factors that may influence or bias a conclusion drawn by a particular perspective and associates those factors with an identifier of that perspective.

Here, the designer might populate that Influencers_ID record with data that identifies “stock market prices” as a potential influencer of the user perspective. This record might also comprise a key, index, or linking element that associates the record to a perspective record in a POV table 451, where the linked perspective-record identifies the current (consumer confidence-related) perspective. This linking represents the designer's observation that a value of “stock market prices” may bias or otherwise influence conclusions drawn by a user who has adopted the “consumer-confidence” perspective. Thus, in this example of step 301, records are populated in a straightforward way in order to represent a designer's knowledge that stock market prices may indirectly influence a business's perspective on product plans. As will be shown in step 305, embodiments of the present invention may further identify other types of influences and biases that are unknown to the designer during the performance of step 301. Such biases may comprise, but are not limited to: overestimating existing product value, failing to recognize changing market trends, or failure to account for an effect of a “we know best” or a “not invented here” corporate culture.

Other types of characteristics and logical relationships relevant to a user's perspective on an objective might, by similar means, be manually entered into the user-perspective data structure in step 301 as a function of knowledge possessed by a system designer or other expert skilled in the art or as a function of information accessible to a system designer or other expert skilled in the art.

In an other example, an embodiment of the present invention might, in step 301, populate the Object table 431 with records that each identify an objective being evaluated and that each associate the identified objective with an “ObjectType” field, which identifies a type of objective associated with the current user perspective, and with a “Domain” field that identifies a type of domain associated with the type of objective.

One such record might identify a proposed “idea”-type objective of modifying the user's product line by “increasing the size of cell-phone displays” by storing an “idea” value in an instance of the ObjectType field “idea” and by storing a value of “mobile technology” in the corresponding Domain field of the same record. Such a record may respectively link that record to a first corresponding record of the Object_Type table 433 and to a second corresponding record of the Domain table 435, where the Object_Type table 433 stores further information about objective types and the Domain table 435 stores further information about domains that may be associated with the current user perspective.

Such a data organization might represent a relationship that categorizes the objective of increasing display size as having an objective type of “idea,” and as falling within a “mobile technology” domain. Variations of such an approach might further apply a similar approach to further associate an objective, an objective type, or an other characteristic of the current user perspective, with a hierarchical taxonomy of domains and sub-domains, or a with a hierarchical taxonomy of other data elements comprised by tables or other data structures populated in step 301.

Using similar or analogous procedures, other relationships and data elements may be populated into the user-perspective data structure instance of the data model. When evaluating a cost or a benefit of introducing a proposed product line, for example, a procedure of step 301 may comprise populating the user-perspective data structure with data and relationships that provide context for an analysis of step 307, where the data and relationships may comprise a characteristic of a new market that is related to a proposed product line, a possible impact of a proposed product line on an existing product, a consumer trend, a technological trend, or a bundling opportunity.

In practice, populating the user-perspective data structure may be complex and may involve populating a larger number of records in order to represent a complex data model or to represent complex or nuanced relationships among a large number of factors. In all cases, however, each subtask of this populating may be performed in a straightforward manner by creating and revising data elements using data-structuring or data-storage tools known to those skilled in the art, and the identification of which data elements and relationships to embed into the user-perspective data structure may be performed in a straightforward manner by a person familiar with the a goal, priority, method or convention of a user, of an objective under evaluation, or of a contextual factor associated with the user, the objective, or the evaluation.

In some embodiments of the present invention, creating and initializing a user-perspective data structure instance of a data model in step 301 may comprise an administrator, project manager, designer, expert, or other entity manually or automatically populating a subset of tables of the user-perspective data structure.

These tables (further described in FIGS. 4A-4E) may comprise the following tables:
Analysis table 453
Analysis_Type table 455
Benefits table 489
Context table 427
Cost_Type table 491
Domain table 429
Enabler table 443
Ideas table 467
Influence_Type table 445
Influencers table 447
Inhibitor table 441
Object table 431
Object_Type table 433
Opportunity table 473
POV table 451
POV_Type table 449
Processes table 471
Products table 469
Questions table 421
Strategies table 461

As explained above, each record of these initially populated tables may represent or may otherwise be a function of a business rule or of an other principle identified as characterizing: a perspective or viewpoint by means of which a user may view, qualify, quantify, interpret, characterize, or otherwise evaluated an objective; an objective that may be evaluated by means of the present invention; or a contextual element associated with a context of a perspective, viewpoint, objective, or procedure associated with evaluating.

In step 303, the new user-perspective data structure instance of the data model initialized in step 301, is “qualified” or otherwise provided context by further populating it with information gathered by the Perspective QA Contextual Evaluator 203. In some embodiments, information gathered by the Perspective QA Contextual Evaluator 203 module may be further used to qualify or otherwise provide context for an other instance of the perspective data model that represents an other perspective stored in the Perspective Database 201.

The Perspective QA Contextual Evaluator 203 may qualify or otherwise provide context by collecting contextual information associated with a characteristic of a perspective by which a user may qualify, compare, test, score, rank, or otherwise characterize an objective, where the objective may comprise one or more ideas, strategies, processes, products, opportunities, or other entities under consideration.

As will be described below, the objective being evaluated may be an idea, a product, a process, an opportunity, or an other entity that a combination of organizational or individual users has identified as being a subject of an evaluative process. Such an objective may, for example, be an idea for reorganizing a marketing department, a financing opportunity, a proposal to expand an existing product line, a more efficient workflow procedure that may streamline a manufacturing process, a new-home purchase, or an opportunity presented by a failure of a former competitor. Embodiments of the present invention may be used to evaluate a broad range of objectives and these objectives may comprise one or more combinations of entities that are capable of being identified, characterized, and evaluated.

The Perspective QA Contextual Evaluator 203 selects questions from the Questions table 421, which contains a set of Questions records stored by a procedure of step 301. Each Questions record stores one question and information that describes a characteristic of, or that describes contextual information associated with, a context of the question. In some embodiments, a question is selected as a function of its ability to narrow, to identify, to refine, or to otherwise qualify a characteristic of one or more users' viewpoint or perspective about an objective being evaluated, where that viewpoint or perspective is currently held by a combination of one or more user organizations, individuals, or other entities.

In a simple example, a record of the Questions table 421 may comprise three fields: a QuestionID, an ObjectType, and a QuestionText, where an instance of the QuestionID field comprises a sequence of alphanumeric characters that uniquely identifies a particular question, an instance of the ObjectType field comprises an identifier that identifies an objective type of an objective that may be associated with the question, and an instance of the QuestionText field comprises the text of the question. Depending on implementation details, a Questions record may further comprise other or different fields, and any field in a Questions record may be defined to be any size or to stored data in any data format consistent with a characteristic of the embodiment.

The Perspective QA Contextual Evaluator 203 may select questions as a function of a type of, intended use of, or other characteristic of an objective under evaluation. In some embodiments, a question may be further selected as a function of an answer to a previous question. A question may comprise any form known to those skilled in the art of information-gathering or research, including, but not limited to, multiple-choice questions, scaled-response questions, or open-ended questions.

In some embodiments, the records of the Questions table 421 may comprise types of “Who/What/When/Where/Why/How” questions traditionally used by journalists and researchers to identify or confirm context of an objective or issue. If an objective under evaluation is, for example, a new product, these questions might ask one or more questions of the form: “Who would use the product?”, “What is the nature of the product?”, “When would the product be launched?”, “Through which channels would the product be sold?”, “Why would such a product be introduced into an existing product line?”, or “How would the product be manufactured?”.

In this example, the Questions table 421 might include 4 records that each comprise a value of “product” in the ObjectType field, indicating that a question associated with a record should be considered when evaluating an objective that is characterized as having objective type “product,” and further include 3 other records that each comprise a value of “opportunity” in the ObjectType field, indicating that the question associated with the record should be considered when evaluating an objective that is characterized as having objective type “opportunity.”

These 7 records might thus contain the information:

| QuestionID | ObjectType | QuestionText |
|---|---|---|
| Q01 | product | Which age group is most likely to use |
| | | this product? |
| Q02 | product | Do purchases of this product vary |
| | | seasonally? |
| Q03 | product | Through which channels is the product |
| | | most often purchased? |
| Q04 | product | In which countries are sales of this |
| | | product most sensitive to price |
| | | fluctuations? |
| QA1 | opportunity | Does this business have a history of |
| | | successfully taking advantage of |
| | | similar opportunities? |
| QA2 | opportunity | Is the business currently taking |
| | | advantage of a similar opportunity? |
| QA3 | opportunity | Does the business have financial |
| | | resources necessary to take |
| | | advantage of this opportunity? |

In this simple example, an embodiment of the Perspective QA Contextual Evaluator 203 that is evaluating a product might thus consider selecting only the first four records, which each identify a question associated with an ObjectType=“product.” The embodiment might then ask some or all of those four questions of a user (possibly depending on the occurrence or nonoccurrence of one or more other conditions) and then populate one or more records of the Answer table 425 as a function of one or more of the answers. In this example, if a response to question Q03 (“Through which channels is the product most often purchased?”) comprised the answer “Internet merchants and high-volume department stores,” the Perspective QA Contextual Evaluator 203 might then create a first new record in the Answer table 425 and populate it with data that associates question Q03 with the answer “Internet merchants” and further create a second new record in the Answer table and populate the second new record with data that further associates question Q03 with the answer “high-volume department stores.”

In a further example, this procedure might further associate a Questions record that identifies question Q03 with two Answer records that identify current answers to question Q03 by means of QA table 425. Here, QA table 425 comprises an intersection of the Questions table 421 and the Answer table 423 by means of keys, indexes, or an other type of linkage that allow a query of joined or intersected records of the Answer table 423 and the Questions table 421.

Other implementations based on different platforms, data structures, and relationships among data elements are possible, but all comprise analogous procedures, wherein the Perspective QA Contextual Evaluator 203 selects questions from the Questions table 421 by means of criteria such as a value of the field ObjectType, presents the selected questions to one or more users, and stores information associated with the users' answers in Answer table 423. In some embodiments, these data elements may not be structured as tables, records, and fields, but the data elements may still be stored in a format and on a platform that represents analogous relationships among the elements.

In other embodiments, a question may be selected by means of more complex selection criteria. For example, if each record of the Questions table 421 comprises an additional field CostSensitivity, questions may be selected from the Questions table 421 as a function of values of both an ObjectType field and a CostSensitivity field.

In some embodiments, a question may be selected or revised all or in part as a function of a previous answer to a question in step 303 or as a function of one or more users' answers to questions presented prior to the current performance of step 303. For example, if a user answers question Q01 (“Which age group is most likely to use this product?”) with an answer “18-24 year-old college students,” an embodiment might use this answer to select a next question that requests information specific to individuals within the 18-24 year-old college-student demographic or to revise a next question to request information specific to the 18-24 year-old college-student demographic.

Here, this selecting or revising may be performed as a function of one or more fields that associate questions with characteristics that may be associated with user age demographics. In other embodiments, such a selecting may be performed by means of a further grouping, subgrouping, or other organizing of records in the Questions table 421, the QA table 425, the Answer table 423, or other components of a perspective data structure. In some cases, questions and answers may be represented by an extendable hierarchical taxonomy that allows complex, nuanced, or conditional methods of information-gathering. All of these information-gathering techniques may be designed and implemented by means of tools and procedures known to those skilled in the arts of analytics, user-interface design, artificial intelligence, database design, and related fields.

The question-and-answer procedure may be repeated multiple times with a single user or with multiple users, and the selection and sequencing of asked questions may vary with each instance of the procedure. The question-and-answer procedure may be performed through interactive or non-interactive means, where such means may comprise, but is not limited to, a combination of an online or printed form; an interactive real-time computerized user interface; an intelligent questioning interface that may be based on techniques of text analytics, semantic analytics, or other inferential methods; and inferences drawn from third-party information sources.

Some embodiments of the present invention may further use the answers gathered in this step by the Perspective QA Contextual Evaluator 203 to create cross-references between records of tables of the user-perspective data structure by means known to those skilled in the art. Such means may comprise linking records or fields by means of a hyperlink, a database index or key, or an other linking mechanism known to those skilled in the art, wherein a linking mechanism associates a first value stored in a first record of a first table with a second value stored in a second record of a second table.

These cross-references may be used to associate records among tables of the user-perspective data structure. In the embodiment of a user-perspective data structure shown in FIGS. 4A-4E, such associations might be used to represent concepts or relationships comprised by a user perspective by linking records or fields of the following pairs of tables.
POV table 451 with Domain table 435
Domain table 435 with Object table 431
Object table 431 with Object_Type table 433
Object table 431 with Relevance table 435
Relevance table 435 with Context table 427
POV table 451 with Analysis table 453
Analysis table 453 with Analysis_Type table 455
Analysis table 453 with: Strategies table 461, Ideas table 467, Products table 469, Processes table 471, or Opportunity table 473 (as a function of a value of an associated record in the Object_Type table 433)
Strategies table 461 with Alignment table 465
Strategy_Alignment table 463 with Strategies table 461 and Alignment table 465
Cost table 485 with Cost_Type table 491
Cost_Benefit_Scorecard table 483 with Cost table 485, Benefits table 489, and Analysis table 453
Decision_Making_Pattern table 481 with Strategy_Alignment table 463, Analysis table 453, and Realization_Feasibility table 489

In some embodiments, some or all of these cross-references may be identified, created, defined, or populated during step 301.

Each of these cross-reference associations may represent a relationship among components or characteristics of a user perspective that correspond to data elements of the associated records of the user-perspective data structure.

If, for example, a user-perspective data structure is implemented as a relational database schema, a relationship between a record of the POV table 451 and a record of the Domain table 435 may comprise storing a common value of “consumer electronics device” in a Domain_ID primary key of a record of the Domain table 435 and in a Domain_ID foreign key of a corresponding record of the POV table 451. Such a linkage might associate a perspective represented by the POV record with a characteristic or relationship of a domain identified by the corresponding, linked Domain record. The corresponding Domain record might, for example, comprise a field “Parent_Domain” that identifies a parent domain of “consumer electronics.” Embodiments of the present invention might then, through the linkage, associate the linked POV perspective to a the “consumer electronics” parent domain.

Furthermore, if the corresponding Domain_ID record were to be linked to a “seasonal sales increase” record of the Enabler table 443, values stored in a field of the linked Enabler record would be further associated with the POV table record via the POV-Domain linkage. Such linkages and associations might represent contextual information that leads to a conclusion that a user perspective may need to decrease holiday sales projections for a new smartphone product line because similar projects have in the past been too optimistic due to a failure to account for the “seasonal sales increase” enabling bias.

Upon completion of an information-collecting question-and-answer session, the Perspective QA Contextual Evaluator 203 may have populated the Answer table 423 with qualifying information that may then be passed to other modules of the present invention for further interpretation and analysis.

In step 305, modules comprised by an embodiment of the present invention interpret and analyze information gathered in step 303 by the Perspective QA Contextual Evaluator 203. As described above, this gathered information may comprise one or more records added to the Answer table 423 that comprise contextual information that may be used to refine, revise, update, or otherwise qualify the perspective data-structure representation of a user perspective from which the user currently views the objective under evaluation.

This gathered information may be used in step 305 to add contextual information or other qualifying information to a one or more user perspectives identified in the POV table 451 or POV_Type table 449 or to identify bias embedded in the one or more of the user perspectives of the questioned users. In some embodiments, step 305 qualifies only the current user perspective represented by the user-perspective data structure populated by steps 301 and 303.

In step 305, the Perspective Bias Evaluator 205 analyzes records of the Answer table 421 created by the Perspective QA Contextual Evaluator 203 in step 303, where such analyzing is performed in order to identify factors that may influence or bias information collected in step 303. In some embodiments, a procedure of step 305 may further analyze records of the POV_Type table 449 and records of other tables linked to records of the POV_Type table 449 in order to further identify factors that may influence or bias information collected in step 303.

This analysis may be performed though a variety of statistical and other mathematical methods known to those skilled in the art. If, for example, an embodiment is evaluating a feasibility of a new product launch, the Perspective Bias Evaluator 205 may here identify a systematic discrepancy between projected sales figures and actual sales figures of similar past product lines identified by contextual information gathered in step 303. The Perspective Bias Evaluator 205 might then determine that, in perspectives that consider sales figures when evaluating a new product launch, a bias may exist that distorts projected sales figures.

Identifying a bias in this step does not necessarily mean identifying an error. Embodiments of the present invention may correctly interpret an identified bias as being correct or as being expected and understood by a perspective. In the preceding example, a bias associated with a perspective that evaluates new products as a function of initial sales projections may render a user's conclusions based on that aspect of the perspective to be overly optimistic. But if the Perspective Bias Evaluator 205 extracts past sales projections and corresponding actual sales figures from the information stored in the Answer table 421 by the Perspective QA Contextual Evaluator 203 in step 303, and then interprets that extracted information as revealing a bias toward overstating initial sales projections, then the Perspective Bias Evaluator 205 might refine or further improve the accuracy of the current perspective by qualifying the current user-perspective data structure to represent this identified bias.

This identifying of biases and influences may be implemented by means of tools and techniques known to those skilled in the art of information management, business science, database-management, artificial intelligence, or related fields. In some embodiments, wherein specific biases are known to be common or likely, express rules may be coded into a software implementation of the Perspective Bias Evaluator 205, or may be embedded into fields or records of certain tables of the user-perspective data structure.

In some embodiments, the Perspective Bias Evaluator 205 may, in response to identifying a bias or influence, create and store records in the Influencers table 447 and Influence_Type table 445, where these records identify and characterize biases or influences identified in step 305, and where those biases or influences may be associated with one or more particular perspectives.

These Influencers and Influence_Type records may be further linked to records in the Inhibitor table 441 or the Enabler table 443, wherein an inhibitor record may identify or characterize a bias or influence that tends to decrease a value of a parameter of a perspective and an Enabler record may identify or characterize a bias or influence that tends to increase a value of a parameter of a perspective. Such a record may be linked to a record of the Influencers table 447 through a record of the Influence_Type table 445 and may be further associated with a specific perspective by means of linking a record of the Influencers table 447 to a record of the POV table 451.

In the above example, if the Perspective Bias Evaluator 205 identifies a bias in the user information stored in step 303 that influences users to overestimate a sales projection of a new product line, the Perspective Bias Evaluator 205 might respond in step 205 by creating a record in the Influencers 447 table that describes the bias, creating a corresponding record in the Enabler table 443 that identifies the bias as tending to increase, rather than decrease, a sales projection factor or characteristic of a perspective, and links the Influencers and Enabler records by means of a linking record in the Influence_Type 445 table. Finally, the Perspective Bias Evaluator 205 would link the Influencers record to a record of the POV table 451 that identifies a user-perspective record that identifies the biased perspective, thus representing that a sales-projection parameter of this perspective may be influenced in a positive manner by a systematic bias.

In some embodiments, the Perspective Bias Evaluator 205 may further identify biases or influences by similar or analogous functions that may interpret or analyze other data provided by other modules of the present invention, or otherwise stored in the Perspective Database 201 or in an other information repository.

The Perspective Assessment Engine 207 performs further qualifying in step 305 by interpreting or analyzing information gathered, generated, or stored by the Perspective QA Contextual Evaluator 203 in step 303.

The Perspective Assessment Engine 207 uses this interpreted or analyzed information to identify one or more relevant “baseline” perspectives, where a perspective of the identified baseline perspectives may be identified by a record of the POV table 451 or may be represented by a perspective data structure of a plurality of perspective data structures stored in the Perspectives Database 201. Such a baseline perspective may be deemed by the Perspective Assessment Engine 207 to be relevant to one or more users, to the objective being evaluated, or to a characteristic or context-related entity associated with a user or with an objective.

In some embodiments, the Perspective Assessment Engine 207 may identify or select a baseline record as a function of an identification of characteristics of a stored or identified perspective that is useful, appropriate, or relevant to the objective being evaluated, to information stored or inferred from contents of Answer table 421, or to an other characteristic of the user-perspective data structure.

A perspective data structure stored in the Perspective Database 201 may be identified as or otherwise deemed to be relevant to the objective being evaluated as a function of a user, of a perspective, of an objective, or of an implementation-dependent criteria or condition. In some embodiments, a baseline perspective data structure may be selected from a subset of the perspective data structures stored in the Perspective Database 201 by a step of selecting all perspective data structures stored in the Perspective Database 201 that are associated with an objective type or a domain is identical to or similar to an objective type or domain associated with the user-perspective data structure populated by steps 301-305.

In one example, if an embodiment of the present invention evaluates an “idea”-type objective of launching a new cell phone product line, that objective may be associated with a domain of “consumer electronics product line” and with an objective-type of “idea,” where these associations are a function of information collected in step 303 by the QA Contextual Evaluator 203.

Here, the Perspective Assessment Engine 207 may attempt to identify valid “baseline” perspectives by searching through candidate perspectives stored as records of the POV table 451, each of which may identify a perspective data structure stored in the Perspective Database 201. In a variation of this embodiment, the Perspective Assessment Engine 207 may instead or in addition directly search through perspective data structures stored in the Perspective Database 201.

Here, each POV record or stored data structure may be linked, by means of an indexing, linkage, or other data-organization technique known to those skilled in the art, to a corresponding record of the Object_Type table 433 and to a corresponding record of the Domain table 435. In this simple example, the Perspective Assessment Engine 207 would identify potentially relevant baseline perspectives by selecting only those perspectives (embodied as either identifying POV records, complete stored perspective data structures, or both), that are linked to both an Object_Type record that identifies an “idea” objective type and to a Domain record that identifies a domain of “consumer electronics product line.” In a complex, real-world implementation, selecting a baseline perspective by means of such a relevance identification might comprise many such steps or more complex queries, sorts, or searches.

At the conclusion of step 305, the user-perspective data structure created in step 301 (and, in some embodiments, an other perspective data structure previously stored in the Perspective Database 201), will have been qualified by the Perspective Bias Evaluator 205 to account for influences and biases identified by information inherent in the Answer records collected by the Perspective QA Contextual Evaluator 203 in step 303. In addition, the Perspective Assessment Engine 207 will have further used these Answer records to identify a set of baseline perspectives deemed relevant to the user and to the objective being evaluated, and will pass that identification to the Perspective Analysis Engine 209 for further processing in step 307.

In step 307, the Perspective Analysis Engine 209 performs a set of “gap analyses” that compares the user-perspective data structure populated in steps 301-305 with each of the one or more baseline perspective data structures identified by the Perspective Assessment Engine 207 in step 305. Such a gap analysis may comprise directly comparing corresponding fields of corresponding records of corresponding tables of the user-perspective data structure and a baseline data structure.

A choice of these fields, records, tables, or other data structures or conditions may be implementation-dependent, based on decisions made by means of implementation-dependent factors chosen with methods and tools known to those skilled in the art.

If, for example, an embodiment evaluates an objective that comprises a proposed cell-phone product launch, a procedure of step 307 might compare values stored in corresponding records of the Influencers table 447, the Enabler table 443, the Inhibitor table 441, and the Influence_Type table 445, wherein each pair of corresponding records comprises a first record of the user-perspective data structure and an analogous second record of a perspective data structure stored in the Perspective Database 201 and identified as representing a baseline perspective by the Perspective Assessment Engine 207 in step 305.

Here, if the Perspective Analysis Engine 209 determines that a baseline-perspective record identifies a sales-projection bias that is similar in value to a corresponding sales-projection bias identified by a user-perspective record, then the two data structures would be deemed in step 307 as being more similar and as being separated by a smaller “gap.” Or, in more qualitative terms, the baseline perspective data structure would be judged as being more relevant to the user or to the objective under evaluation, and thus a better candidate for being recommended by the embodiment in step 313.

In this example, if the identified bias is assigned a weighting factor that is a function of an importance of the biased parameter to an identification of a relevance of the perspective, the gap analysis might be performed as a function of the weighting.

Some embodiments might further determine that such a bias evaluation should be comprised by a gap analysis of step 307 by considering other characteristics of the data structures or of implicit logic embedded into the data structures. Such logic might, for example, be inferred if a record of POV table 451 is linked, directly or indirectly by means of cross-references or other linking mechanisms, to a value of a record of Object table 431 that identifies objectives of type “product,” to a value “cell phone” of a record of “Domain” table 429, to a value “sales projection” of a record of table Relevance 435, and to further values that identify the sales projection bias stored in records of Influencers table 447, Enabler table 443, Inhibitor table 441, and Influence_Type 445. Such stored structures might allow the embodiment to conclude that, because the current user perspective is associated with an objective of type “product” and domain “cell phone,” that sales-projection figures are a relevant component of the user perspective. Furthermore, the embodiment might also be able to conclude that baseline perspectives that comprise a sales-projection bias similar to a bias identified in step 305 should be separated from the current user perspective by a smaller gap.

Many other types of gap-analysis procedures and methods of determining relative relevance of a baseline perspective may be implemented as computer program instructions of the Perspective Analysis Engine 209 or from implicit logic inferred from the perspective data model or from information with which an instance of the data model is populated. In all cases, Perspective Analysis Engine 209 may identify or derive all conclusions, conditions, identifications and characterizations of relevance, and relationships among data elements comprised by step 307 as functions of business goals, objective characteristics, or other implementation-dependent factors, using tools and techniques known to those skilled in the art of database design, information technology, management science, or related fields.

Each gap analysis of step 307 may thus identify a quantifiable “gap” between the user-perspective data structure and one of the baseline perspective data structures selected by the Perspective Assessment Engine 207 in step 305. Each identified gap will be identified as a function of a degree of difference between a pair of corresponding weighted values, fields, records, or other data elements of the two compared data structures. As described above, each such function may be implementation-dependent and may be defined by a person skilled in the art as a function of a known characteristic of a user, of an objective, or of contextual information associated with a user or an objective.

At the conclusion of step 307, the Perspective Analysis Engine 209 will have scored each baseline perspective identified by the Perspective Assessment Engine 207 in step 305 as a function of user contextual information collected by the Perspective QA Contextual Evaluator 207 in step 303 and by further weighting a subset of the scores as a function of biases identified by the Perspective Bias Evaluator 205 in step 305.

In step 309, the Perspective Outcome Evaluator 211 uses a result of the one or more gap analyses performed by the Perspective Analysis Engine 209 in step 307 to assign a score and a relative rank to each baseline perspective compared to the user-perspective data structure in step 307.

The means by which the Perspective Outcome Evaluator 211 assigns or scales a score and assigns a rank may be a function of techniques and methods known to those skilled in the art. In a simple example, the Perspective Outcome Evaluator 211 may order the analyzed baseline perspectives as a monotonically increasing function of the relative size of their gaps, or may number them in order of increasing or decreasing gap size, wherein an absolute or relative gap size of each baseline perspective data structure was determined by the Perspective Analysis Engine 209 in step 307 as a function of how closely a value comprised by an analyzed baseline perspective data structure matches a corresponding value of the user-perspective data structure, as a further function of the degree of relevance assigned to the compared values, and as a further function of one or more biases associated with the compared values and identified by the Perspective Bias Evaluator 205 in step 303.

In step 311, the Perspective Outcome Evaluator 211 may filter the ordered or ranked baseline-perspective data structures that were ordered or ranked in step 309. This filtering may be optional in some embodiments or may be omitted from some embodiments.

The filtering may be performed automatically as an implementation-dependent function of criteria or conditions defined by a designer, administrator, manager, business specialist, expert, or other person skilled in the art of information technology, management science, or a related field. A filtering operation may, for example, be performed as a function of resource limitations, wherein the filtering rejects an otherwise-relevant baseline perspective that would generate a recommendation that requires more capital investment, manpower, execution or implementation time, or other resources to implement than a user individual or organization may be willing or able to commit.

In some embodiments, a filtering may be performed by identifying selected baseline perspectives to a user or by presenting a characteristic of the selected baseline perspectives to a user and by then requesting the user to identify any presented perspectives that are infeasible within the constraints of the user's current business strategy, resource availability, or other user-identified constraint or consideration. The Perspective Outcome Evaluator 211 then removes the infeasible perspectives from the list of ranked and ordered perspectives.

In step 313, the Perspective Outcome Evaluator 211, as a result of the procedures of steps 309 and 311, may identify one or more baseline perspectives as recommended perspectives that are most relevant to the user and to the objective being evaluated and that produce the most effective or accurate outcomes.

In some embodiments, steps 309-311 may be combined, may be performed in a different order, or may be partially omitted.

FIG. 4A illustrates a high-level organization of a minimum embodiment of a perspective data model, in accordance with embodiments of the present invention. FIG. 4A comprises items 401-415, all of which is shown in greater detail in FIGS. 4B-4E.

As described above, the embodiment of the perspective data model shown in FIG. 4 is a minimum implementation of a perspective data model comprised by embodiments of the present invention.

The embodiment of the perspective data model shown in FIG. 4 is extensible, meaning that additional data elements and logical relations may be added to it, as required by a specific embodiment or implementation.

FIG. 4A describes an embodiment of a perspective data model implemented as a schema of a relational database and FIGS. 4B-4E describe data structures comprised by the data model as tables, records, and fields of the schema. But embodiments of the perspective data model may be implemented in any form and by any means known to those skilled in the art. Possible implementation options comprise, but are not limited to, implementation as a schema or sub-schema of a relational database, as a set of flat files, as one or more Excel worksheets, as a comma-delimited table, or as unstructured text.

Instances of the perspective data model include the user-perspective data structure that is created, initialized, and populated by the method of FIG. 3, and other perspective data structures that may be stored in the Perspective Database 201.

Each instance of a perspective data model represent characteristics of a perspective or viewpoint by which a user may evaluate an objective. A first instance of the perspective data model may, for example, comprise a user-perspective data structure that stores information characterizing a user's perspective, viewpoint, point of view, or way of evaluating an objective, such as a product launch, a factory construction, a discontinuation of an existing product, an automobile purchase, or a job change.

FIG. 4A comprises an overview of an entire perspective data model or data structure that is, for clarity, described as an embodiment implemented as a schema of a relational database.

Item 401 comprises a set of data structures that identify and characterize questions that an embodiment of the present invention may present to users and answers to those questions returned by users in response to the presenting. Components of item 401 are described in greater detail in FIG. 4B.

Item 403 comprises a set of data structures that identify and characterize objectives that may be evaluated by a user of an embodiment of the present invention and domains that characterize those objectives. Components of item 403 are described in greater detail in FIG. 4B.

Item 405 comprises a set of data structures that identify and characterize contextual information that may be used to characterize a perspective and relevance factors that characterize how relevant each element of contextual information is to a particular objective. Components of item 405 are described in greater detail in FIG. 4B.

Item 407 comprises a set of data structures that identify and characterize perspectives, viewpoints, or points of view that may be adopted by a user when evaluating an objective and influencers that may bias conclusions drawn by a user who has adopted a particular perspective. Components of item 407 are described in greater detail in FIG. 4C.

Item 409 comprises a set of data structures that identify and characterize possible user strategies that may be selected in response to a choice of a particular user perspective and alignments that characterize how a strategy might support (or align with) a user goal. Components of item 409 are described in greater detail in FIG. 4D.

Item 411 comprises a set of data structures that identify and classify types of analysis that may be used by an embodiment of the present invention to create a user perspective. Components of item 411 are described in greater detail in FIG. 4C.

Item 413 comprises a set of data structures that identify and characterize types of objectives that may be evaluated by a user of an embodiment of the present invention, where those types may include ideas, products, processes, and opportunities. Components of item 413 are described in greater detail in FIG. 4D.

Item 415 comprises a set of data structures that identify and characterize cost and benefit components of a decision-making pattern associated with characterization of a perspective that may be adopted by a user of an embodiment of the present invention. Components of item 415 are described in greater detail in FIG. 4E.

FIG. 4B illustrates details of items of FIG. 4A that show the Questions & Answer substructure 401, the Objectives & Domain substructure 403, and the Context & Relevance substructure 405 of a minimum perspective data structure in accordance with embodiments of the present invention. These details are represented in this example as tables of a relational-database schema, but, as described above, may be implemented in any appropriate data-storage form known to those skilled in the art. The descriptions of each record in these tables is not intended to limit embodiments to the record structures or fields listed here, but are instead intended to merely illustrate a general purpose of each table. In other embodiments, each table may comprise additional or analogous data elements and linkages. FIG. 4B comprises items 401-407 and 421-435.

Items 401, 403, 405, and 407 represent correspondingly numbered items in FIG. 4A.

Item 421 is a Questions table, which, as described in FIGS. 2-3, stores a set of questions from which the Perspective QA Contextual Evaluator 203 may select questions to present to a user in step 303 in order to identify or refine contextual information about an objective being evaluated or about the user.

In some embodiments, each record of Questions table 421 may comprise a text of a question and an identifier of a the question that may be used to associate the question to an answer or to other contextual information associated with the question, where this other contextual information may be used by the Perspective QA Contextual Evaluator 203 in step 303 to select which questions to present.

A question stored in the Questions table 421 may take the form of a journalist's context-gathering “Who/what/when/where/why/how?” question, such as: “What metrics will be measured?”, “Where will metrics be collected?”, “When will the metrics be collected?”, “How will each metric be collected?”, “Who is your target audience?”, “How much will a proposed product cost?”, or “When would the product be launched?”

Answer table 423 stores user responses to questions selected from the Questions table 421 and presented to the user by the Perspective QA Contextual Evaluator 203 in step 303.

QA table 425 is a cross-reference that may associate questions stored in Questions table 421 with answers stored in Answer table 423. As with other cross-references described herein, this cross-reference may be implemented by any means known to those skilled in the art of data storage or representations, such as an index or key of a relational database, a field of an inverted database, or a sortable column of a spreadsheet.

If, for example, an Answer record in Answer table 423 may comprise an AnswerID field that identifies an answer to a question stored in a particular record and a Questions record in Questions table 421 may comprise a QuestionID field that identifies the question stored in a particular record. In this example, a record of the QA table 425 may allow an embodiment to relate a stored question to a stored answer by comprising both an AnswerID field and a QuestionID field. If, for example, a user responded to Question Q01 with an answer that the Perspective QA Contextual Evaluator 203 stored as answer A08 in the Answer table 423, then the QA table 425 might contain a record that identifies and relates QuestionID Q01 and AnswerID A08.

Like the Answer table 423, the QA table 425 may be populated by the Perspective QA Contextual Evaluator 203 in step 303.

A record of the QA table 425 may further comprise other fields that comprise identifiers that allow it to cross-reference a question or an answer to other parameters stored in a perspective data structure. In the example of FIG. 4B, such other fields may link a QA record directly or indirectly to information stored in the Context table 405, a Relevance table 429, an Object table 431, and a Domain table 435. Many other relationships and linkages are possible, and may be implemented by means of tools and techniques known to those skilled in the art, in order to represent a characteristic of a system, objective, user, or perspective being modeled by an embodiment of the present invention.

Context table 427 identifies “who/what/where/why/when/how”-style contextual information that may be all or partly inferred from a user's answers to questions posed by the Perspective QA Contextual Evaluator 203 in step 303 and may be all or partly derived from records of the Answer table 423 stored in step 303, by means of the cross-reference of QA table 425.

This contextual information may be linked, by means of one or more cross-reference fields of each record of the Context table 427, to corresponding records of other tables, such as the Object table 431 and the Relevance table 429. These linkages allow contextual information, including information gathered during step 303 and information prepopulated during an initialization task of step 301, to be associated with other characteristics of a perspective or an objective, such as a parameter that identifies a relevance of a perspective or an objective to a user, to an other objective, or to an other perspective.

A record of the Relevance table 429 identifies a degree of relevance of an objective with an other entity comprised by a perspective data structure, such as a user, an other objective, or an other perspective. A Relevance record may identify such relationships or associates through cross-reference linkages that associate the Relevance record to records of other tables, such as the Context table 427 or the Object record 431, and may further identify indirect relationships through other linkages comprised by records to which the Relevance record links.

In some embodiments, such associations may allow an embodiment of the present invention to relate two or more objectives by means of related or relevant characteristics common to pairs of those two or more objectives. In one example, such linkages may allow an embodiment to relate, or to establish that each is relevant to the other or shares common relevance to a third entity, a product to an advertising campaign, and to then, in a similar manner, relate the campaign to a marketing strategy.

A record of Object table 431 stores information about an objective that may be evaluated by one or more users by means of a user perspective. In some embodiments, each Object record may comprise other, implementation-dependent fields that store data describing characteristics of the objective.

In the embodiment shown in FIG. 4B, a minimal exemplary record of the Object table 431 may comprise a linking Object_ID objective identifier, a textual description of the object, and cross-references to the Domain table 435 and to the Object_Type_ID table 433. Such a data structure allows an objective identified by the Object table 431 record's objective identifier to be associated with a domain described by a record of the Domain table 435, and to be further associated with an objective type described in the Object_Type table 433.

As described above, an objective type may be any broad classification that may be used to categorize an objective and to allow the objective to be associated with greater relevance to characteristics or parameters that identify a similar objective type. An objective type may associate an objective with a category that may comprise, but is not limited to, “product,” “process,” “opportunity,” “proposal,” or “idea.”

As described above, a domain identifies a grouping or functional area that is associated with an objective. An objective may be associated with a set of nested or hierarchically organized domains and sub-domains that may be organized into a tree or directed graph structure. In one example, an objective of “launching a new magazine” may be associated with a domain “media and publications,” that is a sub-domain of a parent domain “photography and graphic reproduction.”

Tables 431-433 thus form a linked cross-reference that may relate an objective being evaluated by a user to a domain that describes a context of the objective and an objective type that, as described above, categorizes the objective.

FIG. 4C illustrates details of items of FIG. 4A that show the Perspectives & Influencers substructure 407 and the Analysis substructure 411 of a minimum perspective data structure in accordance with embodiments of the present invention. These details are represented in this example as tables of a relational-database schema, but, as described above, may be implemented in any appropriate data-storage form known to those skilled in the art. The descriptions of each record in these tables is not intended to limit embodiments to the record structures or fields listed here, but are instead intended to merely illustrate a general purpose of each table. In other embodiments, each table may comprise additional or analogous data elements and linkages. FIG. 4C comprises items 407, 411, and 441-455.

Items 407 and 411 represent correspondingly numbered items in FIG. 4A.

Items 441-447 form a substructure of a perspective data structure, wherein the substructure represents effects of biasing “influencers” that may affect an accuracy of a component of a user perspective.

If, for example, a user is attempting to evaluate an objective of a new product launch from the perspective of comparing current market conditions to conditions that existed during previous successful product launches. When questioned about contextual information that may characterize this perspective, by the Perspective QA Contextual Evaluator 203 in step 303, it may be discovered that a sales projection inferred in part from market conditions may be biased by stock market prices. In such a case, stock market prices would be identified by the substructure of items 441-447 as an influencer of the perspective.

In this example, such relationships might be represented by the substructure of items 441-447 as a set of cross-referenced records. This set of records might comprise a POV record of the POV table 451 that identifies a perspective, point of view, viewpoint, or other representation of a possible perspective of a user. Such a record may comprise fields that identify characteristics of the identified perspective and cross-references to other tables that directly or indirectly identify other characteristics of the identified perspective.

One such cross-reference might be a POV_ID value that identifies the perspective of the POV record and links it to corresponding records in other tables. One such corresponding record might be a corresponding record of the POV_Type table 449, which identifies a “type” classification of the perspective. Such a type classification may be implementation-dependent and may be either manually entered by a person skilled in the art who selects and enters the type classification as a function of the person's familiarity with a characteristic of a user or objective associated with the perspective, or of the perspective itself, or entered automatically by computer software that selects and enters the type classification as a function of some other data or relationship comprised by the current perspective data structure or by a record of the POV table 451.

The POV record may be further linked, by means of a cross-reference field of the record, to a corresponding record of the Influencers table 447. In the current example, this corresponding record may identify the “stock market price” influencing bias upon the perspective identified by the POV record.

The corresponding Influencers record may in turn be linked to records in other tables that provide further information that represents characteristics of the identified influencer, where these characteristics may allow the embodiment to better interpret the nature and effect of the influencer.

Such records in other tables may include a cross-referenced record of the Inhibitor table 441, which, if cross-referenced to the “stock market price” Influencers” record, represents that the “stock market price” influencer may bias an associated parameter of the linked POV record to yield a lower value.

Such records in other tables may further include a cross-referenced record of the Enabler table 443, which, if cross-referenced to the “stock market price” Influencers” record, represents that the “stock market price” influencer may bias an associated parameter of the linked POV record to yield a higher value.

The Influence_Type table 445 cross references records in the Inhibitor table 441 and the Enabler table 443 with a record in the Influencers table 447. This cross-referencing allows the Influencers table to quickly identify a source for further information about an influencer represented by a record of the Influencers table 447 by identifying whether further characteristics of that influencer can be found in the Inhibitor table 441 or in the Enabler table 443.

Many other examples are possible and the substructure of items 441-447, like all tables of FIGS. 4A-4E, are extensible, such that additional data elements, fields, linkages, or other representational components may be added to the minimal representations illustrated in the figures here, as required by an embodiment to represent a characteristic of a particular or implementation-dependent objective, user, perspective, or other element of a perspective data structure.

In some embodiments, a characterization of an influencer represented as a record of the Influencers table 447 might be represented in a variant, or even an opposite way. An enabling influencer, for example, might be interpreted by an embodiment as identifying an influence that requires an upward adjustment to a characteristic of a course of action taken in response to a selection of a particular user perspective. In other cases, however, a characterization of an influencer as being “enabling” might mean that a bias exists that causes a characteristic of an identified course of action to have been “enabled” in an inaccurate way, requiring a value of that characteristic to be adjusted downward. In either case, the underlying mechanism and associated data structure are analogous and a choice of a specific direction of action in response to an identification of an influencer may be implementation-dependent, based on knowledge, techniques, or conventions known to those skilled in the art and familiar with the user, objective, perspective, or context.

Common examples of enabling influencers comprise, but are not limited to an existence of an industry standard, a new technology, or a downward trend in the price of raw materials. Common examples of inhibiting influencers comprise, but are not limited to a regulatory requirement, an identification of a market limitation, or a constraining law.

As described above, a record of the POV (Point of View) table 451 identifies characteristics of a perspective and cross-references that perspective to other tables of a perspective data structure that comprises the POV table 451. A POV record may be considered a summary of an entire perspective data structure that identifies the entire perspective data structure and allows characteristics of that entire data structure to be cross-referenced to other tables of the data structure that comprises the POV table 451.

A perspective identified by a POV record may identify a perspective, viewpiont, or other point of view that comprises a user's perception of facts that may affect the user's choice of a course of action taken in response to an evaluation of an objective. A perspective may, for example, identify or characterize a user's perspective as comprising a considering of a combination of factors such as product loyalty, market acceptance, or market response.

A record of the POV table 451 may be linked to a corresponding record of the POV_Type table 449 by means of a cross-reference field, where that cross-reference field may link the two records by means of common POV identifier or other value.

A record of the POV_Type table 449 identifies a perspective type associated with a perspective identified by the record and by a cross-referenced, corresponding record in the POV table 451. A perspective type may characterize a perspective or associate the perspective with a value that may facilitate a perspective filtering or selection process in step 305, 309, or 311. Samples of perspective types may include “positional,” “organizational,” “financial,” “or “competitive advantage.”

A perspective identified by a record of the POV table 451 may be further cross-referenced with a record of the Analysis table 453 by cross-referencing means similar to those described above.

A record of the Analysis table 453 may identify or characterize a type of analysis or other mechanism that is used to create or refine an associated perspective identified by a linked record in the POV table 451. An example of such an analysis may be “market research,” which indicates that an associated perspective was identified and defined by performing a series of market-research tasks.

A record of the Analysis_Type table 455 may categorize an analysis or other mechanism represented by a linked or cross-referenced record of the Analysis table 453. In one example, an analysis type that categorizes a “market research” analysis might comprise a combination of one or more market-research mechanisms, such as surveys, questionnaires, focus groups, personal interviews, observations, and field trials.

Tables 453 and 455 together thus form a substructure that may be used to characterize an analysis that was used to formulate a perspective identified by a record of POV table 451, or that is otherwise associated with the perspective.

FIG. 4D illustrates details of items of FIG. 4A that show the Strategies & Alignment substructure 409 and the Ideas, Products, Processes, & Opportunities substructure 413 of a minimum perspective data structure in accordance with embodiments of the present invention. These details are represented in this example as tables of a relational-database schema, but, as described above, may be implemented in any appropriate data-storage form known to those skilled in the art. The descriptions of each record in these tables is not intended to limit embodiments to the record structures or fields listed here, but are instead intended to merely illustrate a general purpose of each table. In other embodiments, each table may comprise additional or analogous data elements and linkages. FIG. 4D comprises items 409-415, and 461-473.

Items 409-415 represent correspondingly numbered items in FIG. 4A.

Items 461-463 form a Strategies & Alignment substructure of a perspective data structure, wherein the substructure represents user strategies that may be comprised by a course of action undertaken by a user in response to adoption of a user perspective and characterizes these strategies by how well they align with other goals and other contextual information associated with the user.

A record of Strategies table 461 identifies a specific strategy, wherein a strategy may be a specialized plan, method, series of maneuvers or other plan for obtaining a distinct goal. A marketing strategy, for example, might be considered a strategy if it is a plan to create demand for a specific product or service.

When represented as a substructure of a perspective data structure, a strategy identified by a record of Strategies table 461 may identify a possible strategy of a user that might be chosen as a function of a selection of a particular user perspective when evaluating an object. Examples of such possible strategies include: “increase market share by 10%,” “increase gross profit to 35%,” or “expand customer base to include women aged 19-24.” Many other strategies are possible.

Like many tables of a perspective data structure, a record of the Strategies table 461 may further comprise fields that store values that characterize a strategy or that link or cross-reference a strategy to records of other tables. In some embodiments, these cross-reference fields, indexes, or keys may link a Strategies record to a record of the Alignment table 465 or to a record of the Analysis table 453. Other linkages are possible, depending on implementation details.

A record of the Strategies_Alignment table 463 comprises a linkage between a record of the Strategies table 461 and the Alignment table 465, much as other cross-references comprised by a user-perspective data structure link a pair of other tables. In some embodiments, this linkage may be performed by means of a record structure by which a record of the Strategies_Alignment table 463 comprises a Strategies_ID field that identifies a record of the Strategies table 461 and an Alignment_ID field that identifies a record of the Alignment table 465 where the two identified records are associated. Such an association may represent a characterization that a particular objective being evaluated is in alignment with a particular strategy.

In some embodiments, a cross-reference may comprise no more than this linking cross-reference information. But in other embodiments, a record the Strategies_Alignment table 463 may further comprise fields that characterize or provide context for an identified strategy, alignment, or combination of a strategy and an alignment.

The Alignment table 465 characterizes ways in which a particular objective being evaluated may align with a particular strategy identified by a record of the Strategies table 461. An Alignment record might, for example, comprise a representation of an alignment identified by any of the following conditions: “the objective expands the corporate footprint into new geographic regions,” “the objective directly or indirectly generates a gross return on investment of 53%,” or “the objective establishes an opportunity to market an existing product line to college-age users.”

Items 467-473 identify characteristics of objectives that may be evaluated by an embodiment of the present invention. These characteristics may be considered by an analysis procedure of step 307 or step 309 of FIG. 3. Each of these four items characterizes or describes one class of objectives that may be considered and cross-references an objective to records of other tables of the perspective data structure, such as a corresponding record of the Analysis table 453.

A record of the Ideas table 467 identifies and characterizes an objective that comprises an idea, such as a marketing plan, a proposal to change a company priority, or a redistribution of current resources.

A record of the Products table 469 identifies and characterizes an objective that comprises a good or service that an organizational user or individual user makes available, such as a line of computer peripherals, a lawn-mowing service, or a public-safety service.

A record of the Processes table 471 identifies and characterizes an objective that comprises a systematic series of actions directed to some end for some set purpose, such as a workflow, an election process, or an assembly procedure.

A record of the Opportunity table 473 identifies and characterizes an objective that comprises a situation or condition favorable for advancement or successful attainment of a goal, such as a failure of a competitor, a successful investment, a lowering of a tax bracket, or a windfall profit.

FIG. 4E shows details of FIG. 4A's Cost/Benefit substructure 415 of a minimum perspective data structure in accordance with embodiments of the present invention. These details are represented in this example as tables of a relational-database schema, but, as described above, may be implemented in any appropriate data-storage form known to those skilled in the art. The descriptions of each record in these tables is not intended to limit embodiments to the record structures or fields listed here, but are instead intended to merely illustrate a general purpose of each table. In other embodiments, each table may comprise additional or analogous data elements and linkages. FIG. 4E comprises items 409, 411, 415, and 481-491.

Items 409, 411, and 415 represent correspondingly numbered items in FIG. 4A.

Items 461-463 form a Cost/Benefit substructure of a perspective data structure, wherein the substructure enables a performance of a cost/benefits analysis upon a course of action (or “applied strategy”) for achieving an objective under evaluation, where that course of action may be undertaken as a function of a user's adoption of a perspective.

In some embodiments, this cost/benefit analysis may be performed as part of a gap analysis or of an other evaluation of a perspective in step 307 or step 309 of FIG. 3. This cost/benefit analysis may further provide information about the relative attractiveness, accuracy, effectiveness, efficiency, or appropriateness of a particular perspective by characterizing or quantizing one or more benefits that may accrue to a user by undertaking a course of action suggested by the particular perspective as a means of achieving the objective under evaluation.

In some embodiments, these relative benefits of the particular perspective may be quantified by ranking or scoring the particular perspective as a function of comparing a first benefit of the particular perspective to a second benefit that may accrue when the user undertakes a second course of action suggested by a second perspective. In this way, by performing a cost/benefits analysis on each candidate baseline perspective, a method of step 307 may be able to assign each candidate baseline perspective a relative score or rank.

In one example, the Perspective Analysis Engine 209 may in step 307 attempt to identify which perspectives under consideration may provide a best or an acceptable cost/benefit return, and will score or rank each considered perspective as a result of these identifications.

The Perspective Analysis Engine 209 begins this process by retrieving information from the Strategies & Alignments substructure 409 in order to identify previously stored courses of action or applied strategies that align with a goal of the user, and by initializing a record of the Cost_Benefit_Scorecard table 483, which will be used to coordinate and cross-reference information stored in other modules of the Cost/Benefit substructure 415 and to compute or store a score or ranking generated by the current cost/benefit analysis.

The Strategy_Alignment table 463 (or some other module of the Strategies & Alignments substructure 409) responds to the Perspective Analysis Engine 209 by retrieving a record of the Decision_Making_Pattern table 481 that may comprise information validating an aligned course of action or applied strategy as being feasible, or as being otherwise capable of being fully realized within the user's resource constraints.

The Decision_Making_Pattern table 481 stores information that facilitates such a validation by cross-referencing a Strategy_Alignment identifier comprised by a record of the Strategy_Alignment table 463 with a realization feasibility identifier comprised by a record of the Realization_Feasibility table 487.

In this example, an identifier stored in the Strategy_Alignment table 463 may identify a particular course of action or applied strategy as producing an outcome that is aligned with a goal of the user. The Realization_Feasibility identifier then further identifies that the user may successfully undertake the particular course of action or applied strategy with available or easily obtained user resources. These two qualifiers are then cross-referenced to a corresponding record of the Cost_Benefit_Scorecard table 483, thereby identifying whether the course of action or applied strategy suggested by the perspective being analyzed is both aligned with user goals and is feasible within the constraints of user resource availability.

The Cost_Benefit_Scorecard table 483 further gathers and aggregates data from the Cost table 485 and from the Benefits table 489, which respectively, characterize costs and of benefits that might accrue from a user's adoption of the perspective being analyzed or from performance of the strategy or course of action associated with the perspective as a way to achieve the objective under evaluation. Examples of such a benefit comprise, but are not limited to, a higher profit margin, a larger market share, improved employee morale, an early mortgage payoff, or an increase in an individual's employability.

Each record of the Cost table 485 may comprise characteristics of one cost of the applied strategy or course of action being considered, where those characteristics may comprise, but are not limited to, a pattern of resource usage, a cost classification, or a scaling factor. A cost may, for example, identify a resource requirement, a time to implement, or a tax consequence that occurs as a function of selecting a particular applied strategy or course of action.

In the minimal embodiment of FIG. 4E, a cost classification may be identified by means of a cross-reference that links a particular cost described by a record of Cost table 485, with a cost classification or cost type represented by a corresponding record of Cost_Type table 491.

At the conclusion of these steps, a record of the Cost_Benefit_Scorecard table 483 will have been populated with values of, or linkages to, some or all of the data elements described above, where these linkages may include cross-references to characteristics of some or all of these data elements in other tables of the current user-perspective data structure. In the minimal embodiment of FIG. 4E, such a record may comprise storage of or linkages to a feasibility/alignment identification of an applied strategy comprised by the Decision_Making_Pattern table 481, a characteristic of a cost of the applied strategy comprised by the Cost table 485 and the Cost_Type table 491, and a characteristic of a benefit of the applied strategy comprised by the Benefits table 489.

The Perspective Analysis Engine 209 or the Perspective Outcome Evaluator 211 may then in step 307 or step 309, by means of data elements and logical components of the Analysis substructure 411, use this information to determine, through tools, techniques, or other means known to those skilled in the art, a score or ranking of a perspective being analyzed in step 307 or step 309, where the score or ranking is a further function of a characteristic of a course of action or applied strategy that would be suggested by the perspective being analyzed.

In some embodiments, the result of this cost/benefit analysis may be considered when deciding whether to identify the perspective being analyzed as a recommended perspective in step 313; to revise a value returned by a gap analysis in step 307; to score, rank or order the perspective relative to other candidate, user, or baseline perspectives in step 309; or to discard the perspective being analyzed as being infeasible.

What is claimed is:

1. A method for selecting a recommended perspective with which a user may identify a course of action for achieving an objective, wherein the recommended perspective is represented as an instance of a plurality of stored instances of a perspective database schema, the method comprising:
a processor of a computer system initializing a user-perspective data structure, wherein the user-perspective data structure is an instance of the perspective database schema, and wherein the user-perspective data structure is associated with the user's current perspective about the objective;
the processor selecting a sequence of questions as a function of a characteristic of the user;
the processor presenting the sequence of questions to the user;
the processor recording a set of answers returned by the user in response to the presenting;
the processor identifying as a function of the answers a user bias in the user's current perspective;
the processor revising the user-perspective data structure as a function of the identifying a user bias;
the processor choosing a set of baseline perspectives from the plurality of stored instances of the perspective database schema;
the processor comparing the user-perspective data structure to a selected baseline perspective of the set of baseline perspectives;
the processor assigning a score to the selected baseline perspective as a function of a similarity between a first set of information stored in the user-perspective data structure and a second set of information stored in the selected baseline perspective; and
the processor ranking the set of baseline perspectives as a function of the assigning;
the processor selecting the recommended perspective from the set of baseline perspectives as a function of the ranking.

2. The method of claim 1, wherein the objective is chosen from the group comprising an idea, a product, a procedure, and an opportunity.

3. The method of claim 1, wherein the recording the set of answers further comprises storing the set of answers in a first subordinate data structure of the user-perspective data structure, wherein the first subordinate data structure comprises a cross-reference to a second subordinate data structure of the user-perspective data structure that stores a master set of questions from which the sequenced set of questions were selected, wherein the first subordinate data structure further comprises a cross-reference to a third subordinate data structure of the user-perspective data structure that stores contextual information extracted from the set of answers, and wherein the contextual information describes a characteristic of the user's current perspective that is associated with the user or with the objective.

4. The method of claim 1, wherein the choosing comprises choosing a chosen baseline data structure of the set of baseline perspectives from the plurality of stored instances as a function of a shared data element, wherein the shared data element is comprised both by the chosen baseline data structure and by the user-perspective data structure, and wherein the existence of the shared data element represents a relevance of a characteristic of a perspective associated with the chosen baseline data structure to a characteristic of the user's current perspective.

5. The method of claim 1, wherein the assigning a score is a further function of a result of a cost/benefit analysis applied to a course of action for achieving the objective, wherein the course of action is identified as a probable outcome of the user's adoption of the selected baseline perspective.

6. The method of claim 1, wherein the selecting the recommended perspective further comprises determining a feasibility of a course of action for achieving the objective, wherein the course of action is identified as a probable outcome of the user's adoption of the selected baseline perspective, and wherein the determining a feasibility comprises determining whether the user's available resources are sufficient to ensure a possibility of performance of the course of action.

7. The method of claim 1, wherein the initializing comprises creating an empty instance of the perspective database schema and partially populating it with data that represents known characteristics of the user and of the objective.

8. The method of claim 1, further comprising providing at least one support service for at least one of creating, integrating, hosting, maintaining, and deploying computer-readable program code in the computer system, wherein the computer-readable program code in combination with the computer system is configured to implement the initializing, sequencing, presenting, recording, identifying, revising, choosing, comparing, assigning, ranking, selecting.

9. A computer program product, comprising a computer-readable hardware storage device having a computer-readable program code stored therein, said program code configured to be executed by a processor of a computer system to implement a method for selecting a recommended perspective with which a user may identify a course of action for achieving an objective, wherein the recommended perspective is represented as an instance of a plurality of stored instances of a perspective database schema, the method comprising:
the processor initializing a user-perspective data structure, wherein the user-perspective data structure is an instance of the perspective database schema, and wherein the user-perspective data structure is associated with the user's current perspective about the objective;
the processor selecting a sequence of questions as a function of a characteristic of the user;
the processor presenting the sequence of questions to the user;
the processor recording a set of answers returned by the user in response to the presenting;
the processor identifying as a function of the answers a user bias in the user's current perspective;
the processor revising the user-perspective data structure as a function of the identifying a user bias;
the processor choosing a set of baseline perspectives from the plurality of stored instances of the perspective database schema;
the processor comparing the user-perspective data structure to a selected baseline perspective of the set of baseline perspectives;
the processor assigning a score to the selected baseline perspective as a function of a similarity between a first set of information stored in the user-perspective data structure and a second set of information stored in the selected baseline perspective; and
the processor ranking the set of baseline perspectives as a function of the assigning;
the processor selecting the recommended perspective from the set of baseline perspectives as a function of the ranking.

10. The computer program product of claim 9, wherein the objective is chosen from the group comprising an idea, a product, a procedure, and an opportunity.

11. The computer program product of claim 9, wherein the recording the set of answers further comprises storing the set of answers in a first subordinate data structure of the user-perspective data structure, wherein the first subordinate data structure comprises a cross-reference to a second subordinate data structure of the user-perspective data structure that stores a master set of questions from which the sequenced set of questions were selected, wherein the first subordinate data structure further comprises a cross-reference to a third subordinate data structure of the user-perspective data structure that stores contextual information extracted from the set of answers, and wherein the contextual information describes a characteristic of the user's current perspective that is associated with the user or with the objective.

12. The computer program product of claim 9, wherein the choosing comprises choosing a chosen baseline data structure of the set of baseline perspectives from the plurality of stored instances as a function of a shared data element, wherein the shared data element is comprised both by the chosen baseline data structure and by the user-perspective data structure, and wherein the existence of the shared data element represents a relevance of a characteristic of a perspective associated with the chosen baseline data structure to a characteristic of the user's current perspective.

13. The computer program product of claim 9, wherein the assigning a score is a further function of a result of a cost/benefit analysis applied to a course of action for achieving the objective, wherein the course of action is identified as a probable outcome of the user's adoption of the selected baseline perspective.

14. The computer program product of claim 9, wherein the selecting the recommended perspective further comprises determining a feasibility of a course of action for achieving the objective, wherein the course of action is identified as a probable outcome of the user's adoption of the selected baseline perspective, and wherein the determining a feasibility comprises determining whether the user's available resources are sufficient to ensure a possibility of performance of the course of action.

15. The computer program product of claim 9, wherein the initializing comprises creating an empty instance of the perspective database schema and partially populating it with data that represents known characteristics of the user and of the objective.

16. A computer system comprising a processor, a memory coupled to said processor, and a computer-readable hardware storage device coupled to said processor, said storage device containing program code configured to be run by said processor via the memory to implement a method for selecting a recommended perspective with which a user may identify a course of action for achieving an objective, wherein the recommended perspective is represented as an instance of a plurality of stored instances of a perspective database schema, the method comprising:
the processor initializing a user-perspective data structure, wherein the user-perspective data structure is an instance of the perspective database schema, and wherein the user-perspective data structure is associated with the user's current perspective about the objective;
the processor selecting a sequence of questions as a function of a characteristic of the user;
the processor presenting the sequence of questions to the user;
the processor recording a set of answers returned by the user in response to the presenting;
the processor identifying as a function of the answers a user bias in the user's current perspective;
the processor revising the user-perspective data structure as a function of the identifying a user bias;
the processor choosing a set of baseline perspectives from the plurality of stored instances of the perspective database schema;
the processor comparing the user-perspective data structure to a selected baseline perspective of the set of baseline perspectives;
the processor assigning a score to the selected baseline perspective as a function of a similarity between a first set of information stored in the user-perspective data structure and a second set of information stored in the selected baseline perspective; and
the processor ranking the set of baseline perspectives as a function of the assigning;
the processor selecting the recommended perspective from the set of baseline perspectives as a function of the ranking.

17. The system of claim 16, wherein the objective is chosen from the group comprising an idea, a product, a procedure, and an opportunity.

18. The system of claim 16, wherein the recording the set of answers further comprises storing the set of answers in a first subordinate data structure of the user-perspective data structure, wherein the first subordinate data structure comprises a cross-reference to a second subordinate data structure of the user-perspective data structure that stores a master set of questions from which the sequenced set of questions were selected, wherein the first subordinate data structure further comprises a cross-reference to a third subordinate data structure of the user-perspective data structure that stores contextual information extracted from the set of answers, and wherein the contextual information describes a characteristic of the user's current perspective that is associated with the user or with the objective.

19. The system of claim 16, wherein the choosing comprises choosing a chosen baseline data structure of the set of baseline perspectives from the plurality of stored instances as a function of a shared data element, wherein the shared data element is comprised both by the chosen baseline data structure and by the user-perspective data structure, and wherein the existence of the shared data element represents a relevance of a characteristic of a perspective associated with the chosen baseline data structure to a characteristic of the user's current perspective.

20. The system of claim 16, wherein the assigning a score is a further function of a result of a cost/benefit analysis applied to a course of action for achieving the objective, wherein the course of action is identified as a probable outcome of the user's adoption of the selected baseline perspective.
